(19) United States
(12) Patent Application Publication
(10) Pub. No.: US 2015/0294439 A1
(43) Pub. Date: Oct. 15, 2015

(54) INFORMATION PROCESSING DEVICE, IMAGE PROJECTION DEVICE AND IMAGE PROCESSING METHOD

(71) Applicant: KABUSHIKI KAISHA TOSHIBA, Tokyo (JP)

(72) Inventors: Wataru WATANABE, Kawasaki (JP); Yuma SANO, Kawasaki (JP); Ryosuke NONAKA, Yokohama (JP); Masahiro BABA, Yokohama (JP)

(21) Appl. No.: 14/679,196

(22) Filed: Apr. 6, 2015

(30) Foreign Application Priority Data
Apr. 9, 2014 (JP) 2014-079971

(51) Int. Cl. G06T 3/00; G06T 3/20; G06T 3/60; G01B 11/14

(52) U.S. Cl. CPC G06T 3/0056; G01B 11/14; G06T 3/20; G06T 3/60

(57) ABSTRACT

According to one embodiment, an information processing device includes a distance information acquisition unit, an operation detector and an updating unit. The distance information acquisition unit acquires distance information relating to a distance to an object. The object includes at least a portion of a projection surface where an image is projected. The operation detector detects an operation performed by an indicator. The detecting is based on a reference distance and the distance information. The updating unit updates the reference distance based on a temporal change of the detected operation and a temporal change of the acquired distance information.

### CROSS-REFERENCE TO RELATED APPLICATIONS

This application is based upon and claims the benefit of priority from Japanese Patent Application No. 2014-079971, filed on Apr. 9, 2014; the entire contents of which are incorporated herein by reference.

### FIELD

Embodiments described herein relate generally to an information processing device, an image projection device and an image processing method.

### BACKGROUND

An information processing device has been developed to detect an operation (a gesture) performed on an object surface such as a wall, a desk upper surface, etc., by an indicator such as a finger, a pen, etc. Also, an image projection device that uses such an information processing device has been developed. Such an image projection device converts an image projected onto the object surface to remove distortion of the image according to the configuration of the projection surface and the relative positions and orientations of the object surface and the image projection device. Further, the image projection device detects the operation performed by the indicator on the projection image and reflects the detected operation in the projection image. It is desirable to improve the stability of the conversion of the image and the stability of the detection of the operation.

### BRIEF DESCRIPTION OF THE DRAWINGS

FIG. 1 is a schematic view illustrating an image processing device according to a first embodiment;

FIG. 2 is a schematic perspective view illustrating an example of states of use of the information processing device according to the first embodiment;

FIG. 3 is a schematic perspective view illustrating an example of states of use of the information processing device according to the first embodiment;

FIG. 4 is a block diagram illustrating the updating unit of the information processing device according to the first embodiment;

FIG. 5 is a schematic view illustrating the operation of the condition determination unit;

FIG. 6 is a block diagram illustrating the information processing device according to the second embodiment;

FIG. 7 is a schematic perspective view illustrating an example of states of use of the information processing device according to the second embodiment;

FIG. 8 is a schematic perspective views illustrating an example of states of use of the information processing device according to the second embodiment; and

FIG. 9 is a schematic perspective view illustrating an example of the state of use of the information processing device according to the third embodiment.

### DETAILED DESCRIPTION

According to one embodiment, an information processing device includes a distance information acquisition unit, an operation detector and an updating unit. The distance information acquisition unit acquires distance information relating to a distance to an object. The object includes at least a portion of a projection surface where an image is projected. The operation detector detects an operation performed by an indicator. The detecting is based on a reference distance and the distance information. The updating unit updates the reference distance based on a temporal change of the detected operation and a temporal change of the acquired distance information.

According to one embodiment, an image processing method is disclosed. The method includes acquiring distance information relating to a distance to an object. The object includes at least a portion of a projection surface where an image is projected. The method includes detecting an operation performed by an indicator. The detecting is based on a reference distance and the distance information. The method includes updating the reference distance based on a temporal change of the detected operation and a temporal change of the acquired distance information.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

### First Embodiment

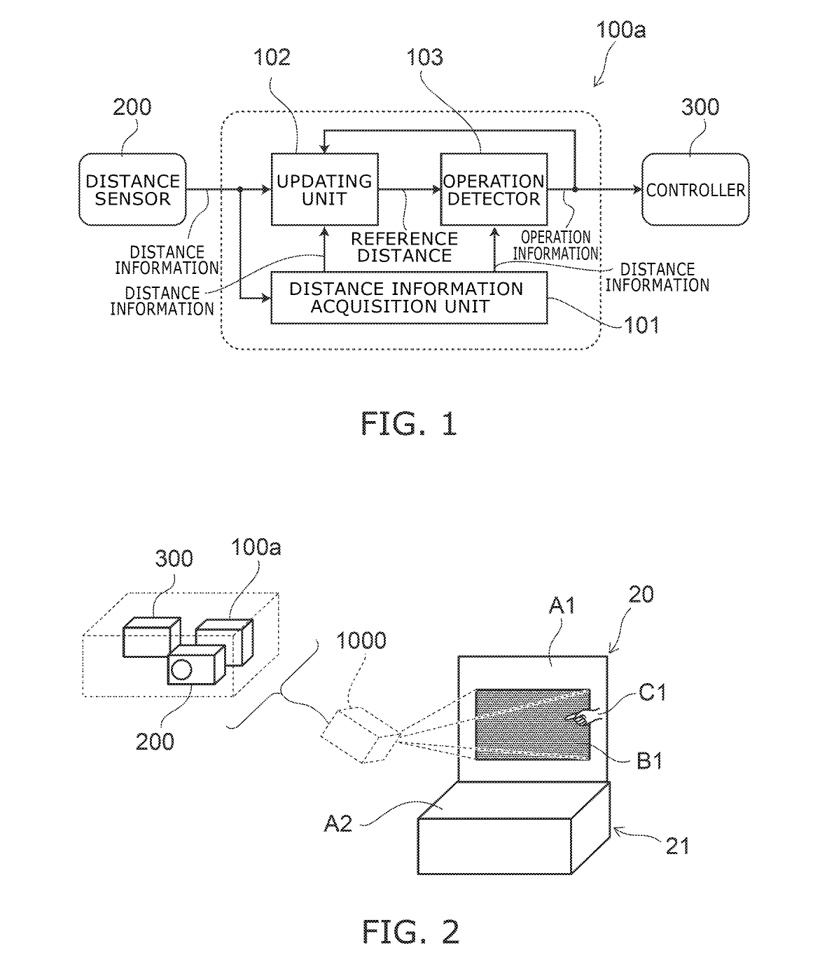

The embodiment relates to an information processing device detecting an operation performed on any object surface. The block diagram of FIG. 1 is an example of the configuration of the information processing device 100a according to the embodiment and does not necessarily match the configuration of an actual program module.

The information processing device 100a shown in FIG. 1 includes a distance information acquisition unit 101, an updating unit 102, and an operation detector 103. In the embodiment, the information processing device 100a is connected to peripheral devices including a distance measuring unit 200 (a distance sensor) and a controller 300.

External devices that are different from those of the information processing device 100a may be used as the distance measuring unit 200 and the controller 300. The information processing device 100a may include the distance measuring unit 200 and the controller 300. The distance measuring unit 200 and the controller 300 may be built into an image projector 500 described below. The controller 300 is, for example, a computer, etc. The hardware configuration shown in FIG. 1 is an example. An integrated circuit such as LSI (Large Scale Integration), etc., or an IC (Integrated Circuit) chipset may be used as a portion of the information processing device according to the embodiment or as the entire information processing device according to the embodiment. Each functional block may be provided with a processing feature individually. A portion of each functional block or each entire functional block may be provided with a processing feature by being integrated. The integrated circuit is not limited to LSI; and a dedicated circuit or a general-purpose processor may be used.

The distance measuring unit 200 measures the distance to an object having a projection surface where an image is projected. For example, the distance information acquisition unit 101 acquires and retains the distance information measured by the distance measuring unit 200.

The operation detector 103 receives the distance information from the distance information acquisition unit 101 and detects an operation performed on the projection surface using the received distance information and a reference distance described below.

For example, the updating unit 102 receives the distance information from the distance information acquisition unit 101. The updating unit 102 also receives information relating to the operation state detected by the operation detector 103. The updating unit 102 appropriately updates the reference distance based on the distance information and the information relating to the operation state that are received. Thus, the operation detector 103 detects the operation based on the updated reference distance.

The controller 300 receives the reference distance and the information relating to the operation state. For example, the controller 300 performs processing such as changing the image based on the received information, etc.

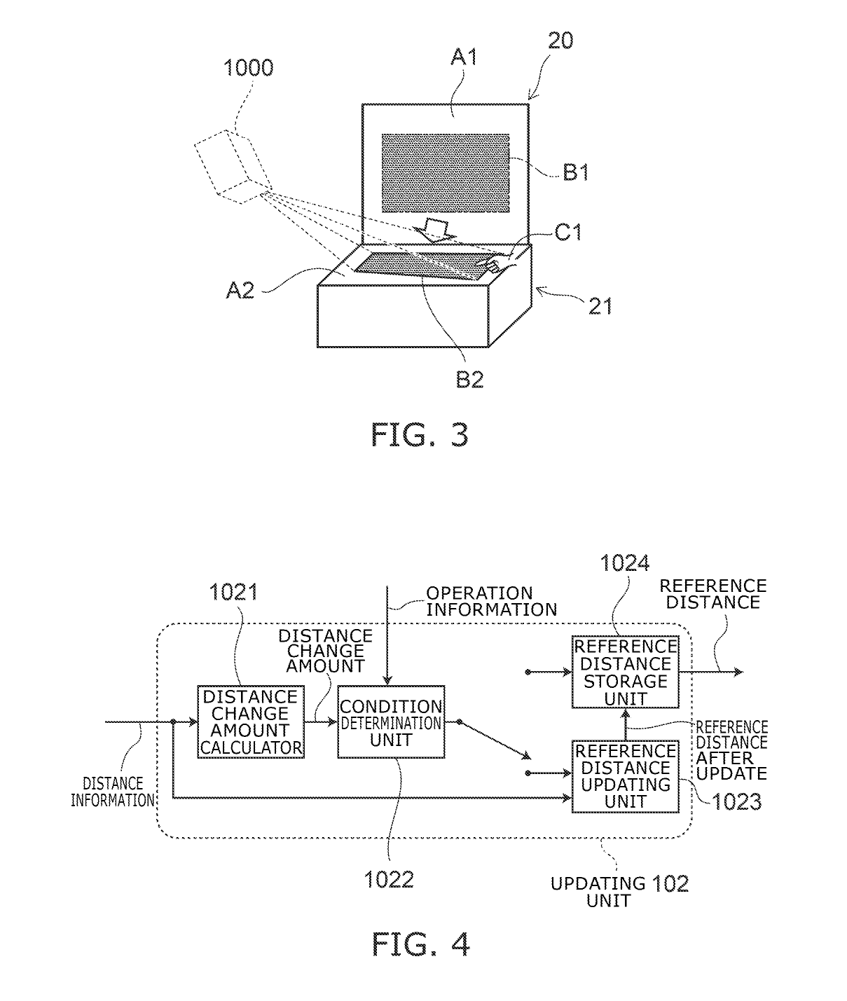

FIG. 2 and FIG. 3 are schematic perspective views illustrating examples of states of use of the information processing device according to the first embodiment.

Although the information processing device 100a, the distance measuring unit 200, and the controller 300 are described as being included in one housing 1000 in the example, the embodiment is not limited thereto. The information processing device 100a and the controller 300 may be disposed in separate locations.

In the embodiment, the distance measuring unit 200 is described as a range image sensor that can two-dimensionally acquire distance information to the object. The range image sensor can acquire the distance to the imaged object as a two-dimensional array (a range image) in the way that a normal camera acquires color information of the imaged object as a two-dimensional array, i.e., an image. The method for acquiring the range image may include an infrared pattern irradiation method (a method for irradiating an infrared pattern onto the object, detecting the pattern by an infrared camera, and measuring the distance by triangulation), a time-of-flight method (a method for projecting light onto the object and measuring the distance by measuring the round trip time of the light), etc. A sensor that uses other distance acquisition methods may be used. The distance information that is acquired by the range image sensor is represented as d(x, y, t). Here, x and y are the image coordinates of the range image that is acquired; and t is the time of the acquisition.

For example, such a sensor can be used to detect the operation by an indicator such as a pen, a pointer, a finger, etc., performed on any object surface such as a wall, a desk upper surface, etc. For example, the distance measuring unit can be used to perform contact determination (touch detection) on the desk upper surface.

An object 20 shown in FIG. 2 has a surface A1. An object 21 has a surface A2. The surface A1 and the surface A2 are object surfaces that may be the object of the operation detection. For example, the surface A1 is a wall surface; and the surface A2 is a desk upper surface. In the embodiment, the object surfaces that are used as the object of the operation detection are described as being planes. The embodiment is not limited thereto. In the embodiment, the object surface may be non-planar and may include an unevenness.

A measurement range B1 shown in FIG. 2 is the range of the distance measured by the distance measuring unit 200. An indicator C1 is, for example, an object such as a finger, a pointer, etc. The indicator C1 performs an operation on the object such as the surface A1, the surface A2, etc. In the embodiment, the operation by the indicator C1 in the measurement range B1 is detected.

Here, the reference distance D₀(x, y) is a distance information between the distance measuring unit 200 and the object surface to be used for the operation detection. The operation performed on the object surface is detected based on the reference distance D₀(x, y) by the operation detector 103 described below. The measurement range B1 may be a portion of the angle of view of the distance measuring unit 200 or the entire angle of view of the distance measuring unit 200.

FIG. 3 shows the state in which the position or orientation (position/orientation) of the housing 1000 has changed. The measurement range B1 changes to a measurement range B2 as the position or orientation of the housing 1000 changes.

Thus, in the case where the position/orientation of the housing 1000 changes, it is desirable for the reference distance D₀(x, y) to be updated automatically and the object surface used as the object of the operation detection to be modified to the surface A2 as the position/orientation changes.

For example, the reference distance D₀(x, y) is updated when the distance between the housing 1000 and the object surface used as the object of the operation detection changes. In other words, the reference distance D₀(x, y) is updated not only when the position/orientation of the housing 1000 is changed but also when the position/orientation or configuration of the object surface is changed.

In the case where only the position/orientation of the housing 1000 is changed, the change can be detected by providing an acceleration sensor, etc., in the housing 1000. However, the change of the position/orientation or configuration of the object surface cannot be detected using only the signal of the acceleration sensor provided in the housing 1000.

The position/orientation of the housing 1000 and the position/orientation and shape deformation of the object surface can be detected by using the temporal change of the distance information such as the temporal difference of the distance information, etc. However, the distance information also changes due to the operation by the indicator C1 as well. For example, the distance information changes when the indicator C1 is disposed between the distance measuring unit 200 and the object surface. Using only the temporal change of the distance information, it is not easy to discriminate between the change of the position/orientation and the change due to the indicator C1.

Therefore, in the embodiment, the updating unit 102 described below appropriately performs an update by determining whether or not to update the reference distance D₀(x, y) based on the temporal change of the distance information and the operation state (the temporal change of the operation) due to the indicator.

The distance information acquisition unit 101 acquires the distance information relating to the distance to the object. For example, the distance information acquisition unit 101 retains the distance information of at least one time acquired by the distance measuring unit 200. The distance information acquisition unit 101 may include a buffer that retains multiple distance information at mutually-different times.

The updating unit 102 appropriately performs an update by determining whether or not to update the reference distance D₀(x, y) based on the distance information of at least one time retained by the distance information acquisition unit 101 and the operation information output by the operation detector 103.

FIG. 4 is a block diagram illustrating the updating unit of the information processing device according to the first embodiment.

A distance change amount calculator 1021 calculates the temporal change of the distance information. The distance change amount is defined by the following formula.

[Formula 1]

Eₜ=(εₜ−εₜ₋₁)² (1)

Here,

$$\begin{matrix}[ Formula 2 ] & \\ {ɛ}_{l} = \frac{1}{{N}_{R O I}} {\sum }_{( x , y ) ∈ R O I}^{ } \vert d ( x , y , t ) - d ( x , y , t - 1 ) \vert . & ( 2 )\end{matrix}$$

ROI is the set of pixels used to calculate the distance change amount inside the range image that is acquired. N_{ROI} is the number of pixels included in ROI.

A condition determination unit 1022 determines whether or not to update the reference distance based on the distance change amount calculated by the distance change amount calculator 1021 and the operation information detected by the operation detector 103. In the embodiment, the reference distance D₀(x, y) is updated when the state continues for a constant interval in which the temporal change amount of the distance information is small and the operation is not performed.

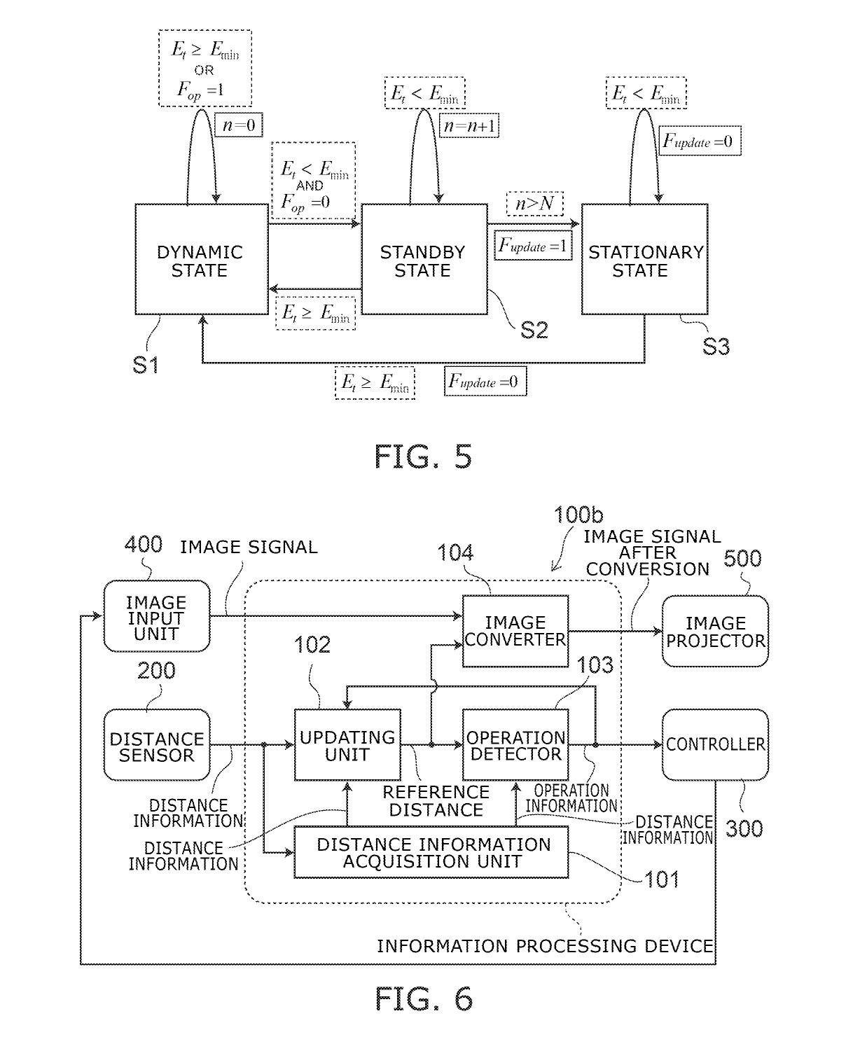

FIG. 5 is a schematic view showing the operation of the condition determination unit.

The process of the condition determination unit 1022 performing the determination is illustrated by a state transition diagram. As shown in FIG. 5, for example, there are the three states of the dynamic state S1, the standby state S2, and the stationary state S3; and the transition between the states is performed based on the conditions enclosed with the broken lines. The processing enclosed with the solid lines is performed in the state transition.

The flow of the state transition will now be described using FIG. 5. Eₘᵢₙ is the threshold for determining the magnitude of the distance change amount. Fₒₚ is a binary variable determined from the operation information. The operation is being performed if Fₒₚ=1. The operation is not being performed if Fₒₚ=0. F_{update} is the output of the condition determination unit 1022; the update is performed if F_{update}=1; and the update is not performed if F_{update}=0. In other words, the updating unit 102 implements a first operation of updating the reference distance D₀(x, y) when F_{update}=1; and the updating unit 102 implements a second operation of not updating the reference distance D₀(x, y) when F_{update}=0.

The initial state is taken to be the dynamic state S1 in the following description. The state remains in the dynamic state S1 when the distance change amount is equal to or greater than the threshold (Eₜ≧Eₘᵢₙ) or when the operation is being performed (Fₒₚ=1).

Here, n is the counter for the state transition; and n=0 while the state remains in the dynamic state S1.

The state transitions from the dynamic state S1 to the standby state S2 when the distance change amount is equal to or less than the threshold (Eₜ<Eₘᵢₙ) and when the operation is not being performed (Fₒₚ=0). The state remains in the standby state S2 and the counter n increases when the distance change amount is less than the threshold. When the distance change amount becomes equal to or greater than the threshold in the standby state S2, the state transitions to the dynamic state S1; and the counter n is reset to 0.

When the counter n increases until n>N, the state transitions from the standby state S2 to the stationary state S3. At this time, the condition determination unit 1022 sets F_{update}=1 and determines to perform the update. When the distance change amount is less than the threshold, the state remains in the stationary state S3; and when the distance change amount is equal to or greater than the threshold, the state transitions to the dynamic state S1. In any case, F_{update}=0. The updating unit 102 does not update the reference distance D₀(x, y) in the dynamic state S1 in which the operation is performed.

Thus, the reference distance D₀(x, y) can be updated when the temporal change amount of the distance information is small and the state in which the operation is not being performed continues for a constant interval.

In other words, in the first operation, the reference distance D₀(x, y) is updated when the interval of detecting that the operation is not being performed continues longer than a predetermined interval.

In the first operation, the reference distance D₀(x, y) is updated when the temporal change of the distance information is less than the reference value (Eₘᵢₙ). For example, the reference distance D₀(x, y) is updated when the interval in which the temporal change of the distance information is less than the reference value (Eₘᵢₙ) continues longer than the predetermined interval.

A reference distance updating unit 1023 recalculates the reference distance D₀(x, y) from the distance information of at least one time retained in the distance information acquisition unit 101. Here, t_{update} is the time of update. The simplest method for calculating the reference distance D₀(x, y) is a method that sets the reference distance D₀(x, y)=d(x, y, t_{update}).

The first operation modifies the reference distance D₀(x, y) based on the distance information of the time of detecting that the operation is not being performed. For example, in the first operation, the reference distance D₀(x, y) is modified based on the distance information of a first time, the first time being when the temporal change of the distance information is less than the reference value (Eₘᵢₙ) and when it is detected that the operation is not being performed.

The reference distance D₀(x, y) may be determined from multiple distance information of mutually-different times retained in the distance information acquisition unit 101 (or a buffer). For example, the reference distance D₀(x, y) may be determined by suppressing the effects of noise, etc., included in the distance information by using the average, mode, median, minimum value, maximum value, etc., of the distance information of the multiple times.

A reference distance memory unit 1024 retains the reference distance D₀(x, y). In the case where the condition determination unit 1022 determines to update the reference distance D₀(x, y), the reference distance D₀(x, y) that is retained by the reference distance memory unit 1024 is updated by the reference distance updating unit 1023.

The operation detector 103 detects the operation using the reference distance D₀(x, y) and the distance information. For example, it is detected that the operation is being performed when the difference between the reference distance D₀(x, y) and the distance information d(x, y, t) is within a designated range. In the embodiment, the touch operation performed on the object surface by the indicator C1 such as a finger, a pen, etc., is detected. The embodiment is not limited thereto. In the embodiment, any type of operation may be detected as long as the operation is detectable based on the distance information.

Because the distance (the reference distance D₀(x, y)) to the object surface is known, the location of the indicator C1 touching the object surface can be discriminated by the following formula.

$$\begin{matrix}[ Formula 3 ] & \\ Near ( x , y ) = \{ \begin{matrix}1 & {D}_{0} ( x , y ) - {D}_{margin} ( x , y ) \leq d ( x , y , t ) \leq {D}_{0} ( x , y ) + {D}_{margin} ( x , y ) \\ 0 & otherwise\end{matrix} & ( 3 )\end{matrix}$$

Here, D_{margin}(x, y) is a parameter for the detection. By setting the parameter appropriately, it can be considered that a touch operation by the indicator is being performed at the position of the coordinates (x, y) if Near(x, y)=1.

When touching is performed by the indicator C1 such as a finger, a pen, etc., that has a certain diameter, the region where the operation of the touching, etc., is performed is detected as a continuous region of pixels where Near(x, y)=1.

When multiple points (regions) of the object surface are touched, the number of continuous regions may be used as the number of points that are touched. Also, the coordinates of the centroid of the continuous region may be used as the coordinates of the region that is touched for each of the continuous regions. Here, regions where the number of continuous components having Near(x, y)=1 is small, i.e., the regions where the continuous surface area of the region is small, may be rejected. Thereby, the operation can be determined while suppressing the effects of the noise included in the distance information, etc.

The number of continuous regions (the number of touch points) and the coordinates (the touch coordinates) of the continuous regions that are detected are output to the controller 300 as the operation information. In the embodiment, the number of continuous regions is 1 or more when the operation is being performed; and the number of continuous regions is 0 when the operation is not being performed. Such operation information is output to the updating unit 102.

The controller 300 determines the operation based on the operation information detected by the operation detector 103. For example, processing such as initiating a touch event, a flick operation, or the like is performed based on the touch coordinates and the number of touch points.

As described above, the change of the position and orientation of the object surface can be detected using the distance information d(x, y, t). However, the distance information changes even when the indicator C1 approaches the object surface. Therefore, in the case where only the distance information d(x, y, t) is used, it is difficult to discriminate between the change of the distance due to the change of the position and orientation of the object surface and the change of the distance due to the gesture. Therefore, there are cases where the change of the distance due to the indicator C1 approaching the object surface is undesirably detected as the change of the position and orientation of the object surface; and the stability of the detection of the operation decreases.

Conversely, in the embodiment, the reference distance D₀(x, y) to the object surface is updated at a favorable timing by referring to the temporal change of the distance to the object surface and the state of the operation performed by the indicator. For example, the stability/comfort of the operation can be increased because the reference distance is not updated when the operation is being performed by the indicator C1.

### Second Embodiment

The embodiment relates to an information processing device that detects an operation performed on an image displayed on any object surface.

For example, the image may be projected onto any object surface such as a wall, a desk, etc., by combining a projector and a sensor. When performing the projection onto any object surface, there are cases where the projection cannot be performed from the frontward direction of the object, or the object surface is non-planar. In such cases, distortion of the image that is projected may occur. In the embodiment, the image is modified based on processing of the information processing device and is displayed on the object surface without distortion.

In the embodiment, the modification of the image according to the configuration of the projection surface is combined with the gesture operation. For example, the operation performed on the projection image by the gesture using an indicator such as a finger, a pen, etc., is detected and reflected in the projection image while changing the projection image to remove the distortion according to the change of the relative positions and orientations of the projector and the object surface to be projected onto.

FIG. 6 is a block diagram illustrating the information processing device according to the second embodiment.

FIG. 6 shows the information processing device 100b and the peripheral devices of the information processing device 100b. In addition to the distance information acquisition unit 101, the updating unit 102, and the operation detector 103, the information processing device 100b of the embodiment further includes an image converter 104.

In the embodiment, the distance measuring unit 200, the controller 300, an image input unit 400, and the image projector 500 are used as the peripheral devices. The information processing device 100b is described as being connected to each of these peripheral devices. In the embodiment, these peripheral devices are provided as necessary.

The embodiment will now be described. For simplification, a description of the portions having operations similar to those of the first embodiment are omitted; and the portions having different operations are described.

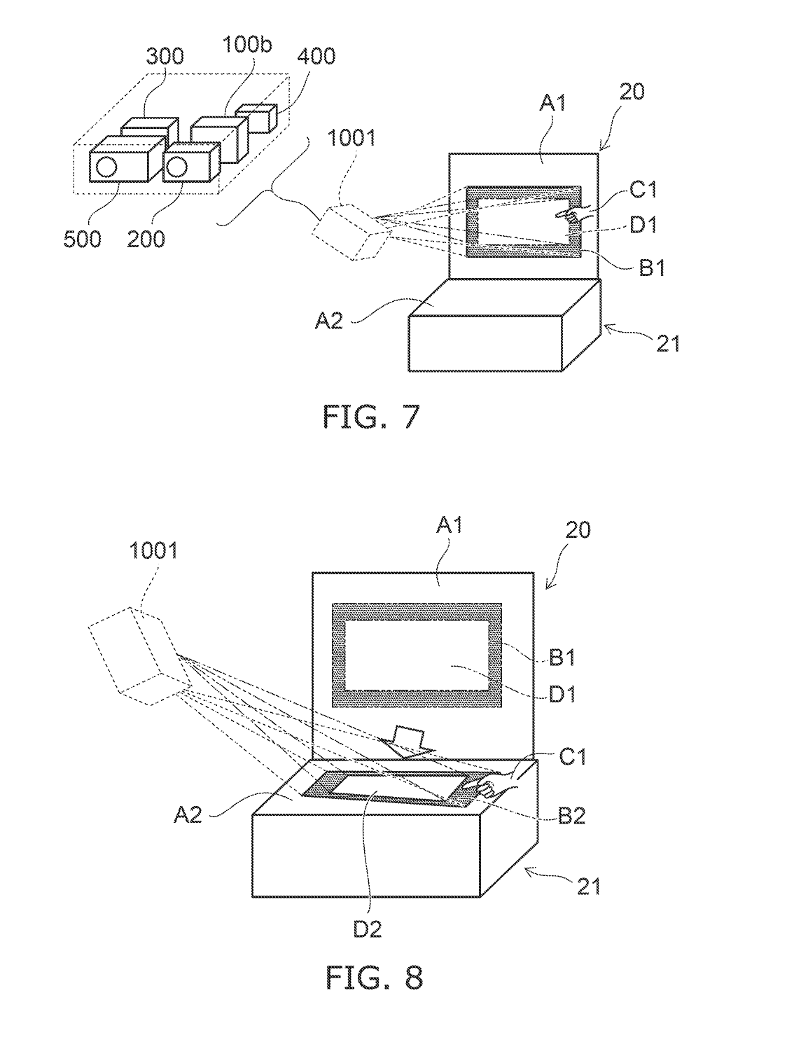

FIG. 7 and FIG. 8 are schematic perspective views illustrating examples of states of use of the information processing device according to the second embodiment.

In the embodiment, the information processing device 100b, the distance measuring unit 200, and the controller 300 are described as being included in one housing 1001. However, the embodiment is not limited thereto. In the embodiment, the information processing device 100b, the controller 300, and the image input unit 400 may be disposed in locations separated from each other.

LSI, an IC, etc., may be used as the information processing device 100b. The information processing device 100b may be built into a projector including the image input unit 400, the image projector 500, etc. The embodiment may be an image projection device (a projector) including the information processing device 100b and the image projector 500.

The information processing device 100b may be provided separately from the projector. A dedicated or general-purpose processor may be used as the information processing device 100b. A processor that is included in the controller 300 (e.g., a computer), etc., may be used as the information processing device 100b. A portion of each functional block of the information processing device 100b may be embedded in the projector as an integrated circuit. Individual processors may be used as a portion of each functional block of the information processing device 100b.

The image projector 500 will now be described as a projector.

As shown in FIG. 7, the image projector 500 projects the image converted by the image converter 104 onto any object surface. The object 20 or 21 has a projection surface (e.g., the surface A1 or A2) where the image is projected. A projection area D1 is the range of the image projected onto the projection surface. The distance measuring unit 200 measures the distance to at least a portion of the projection surface. The distance information d(x, y, t) is based on the distance between the distance measuring unit 200 and the at least a portion of the projection surface.

FIG. 8 shows the state in which the position/orientation of the housing 1001 is changed. The projection area D1 is changed to a projection area D2 according to the change of the position/orientation of the housing 1001. Thereby, for example, there are cases where distortion of the projection image undesirably occurs.

The image converter 104 determines the configuration of the object surface to be projected onto by using the reference distance D₀(x, y) calculated by the updating unit 102. Then, the image is converted to remove the distortion from the configuration of the object surface to pre-estimate the distortion occurring when projecting. It is possible to remove the distortion corresponding to only the position/configuration change of the object surface by ignoring the distance change due to the operation by using the reference distance D₀(x, y) instead of the distance information acquired by the distance measuring unit 200.

The modification to remove the distortion of the projection image can be implemented using two-pass rendering. In two-pass rendering, the position of the viewpoint where the projection image is viewed is predetermined; and the projection image is modified so that the image can be viewed without distortion at the viewpoint. First, a projector is virtually disposed at the predetermined viewpoint position; and the image when the projection image is observed at the position of the actual projector is generated. The generation is possible if the configuration of the projection surface and internal information such as the angle of view of the projector, the resolution, etc., are known. Because the generated image can be considered to have predistortion, the generated image can be projected from the actual projector to remove the distortion from the image observed at the predetermined viewpoint position.

In the case where the projection surface is a plane, the distortion can be removed by existing keystone correction methods without using two-pass rendering because only simple keystone distortion occurs. Because the configuration of the projection surface is known, the parameters necessary for the keystone correction can be determined easily. For example, because the relative angle between the projector and the projection surface is known by calculating the normal of the projection surface, the keystone correction is performed according to this angle.

Similarly to the first embodiment, the operation detector 103 detects the operation based on the reference distance D₀(x, y) and the distance information d(x, y, t). In the embodiment, the operation performed on the projected image is detected. For example, operations such as those of a touch display can be performed on the projection image by detecting the touch operation performed on the projected image. In other words, the image converter 104 converts the image based on the operation that is detected.

For example, the reference distance referred to by the operation detector 103 may be different from the reference distance referred to by the image converter 104. The timing of updating the reference distance referred to by the operation detector 103 may be different from the timing of updating the reference distance referred to by the image converter 104. In other words, the reference distance D₀(x, y) includes a first reference distance and a second reference distance. The operation detector 103 detects the operation based on the first reference distance; and the image converter 104 converts the image based on the second reference distance. The updating unit 102 updates the first reference distance in the first interval and updates the second reference distance in the second interval which is different from the first interval.

The timing at which the updating unit 102 updates the reference distance D₀(x, y) may be adjustable by the user. For example, the threshold Eₘᵢₙ of the distance change amount, the threshold N of the counter n, or the like is adjustable.

For example, an acceleration sensor may be provided in the image projector 500. The timing of updating the reference distance D₀(x, y) may be adjusted (modified) based on the distance information and information relating to the position or orientation of the image projector 500 detected by the acceleration sensor.

The operation detector 103 may detect the type of operation; and the updating unit 102 may modify the timing of modifying the reference distance D₀(x, y) according to the type of operation that is detected. The type of operation includes, for example, tapping (the operation of touching the object surface), flicking (the operation of stroking the object surface), etc.

By these adjustments, D₀(x, y) can be updated at a more favorable timing.

According to the embodiment, the image can be converted to display the image on any object surface without distortion; and operations performed on the displayed image can be detected.

As described above, in the case where the detection is performed using only the distance information (x, y), it is difficult to discriminate between the change of the distance due to the change of the position and orientation of the object surface and the change of the distance due to the gesture. The change of the distance due to the indicator C1 approaching the object surface is undesirably detected as the change of the position and orientation of the object surface or the change of the position and orientation of the projector; unnecessary distortion of the projection image occurs; and there is a risk that the projection image may be disturbed. In such a case, the projection position of the projection image undesirably changes when the operation is being performed by the indicator; and there is a risk that the operation may be difficult. For example, when a touch operation is performed, there are cases where it is difficult to touch the intended position.

Conversely, in the embodiment, the operation is detected based on the reference distance D₀(x, y) and the distance information d(x, y, t). The reference distance D₀(x, y) is updated based on the distance information (x, y) and the state of the operation. Thereby, in the operation by the indicator, unnecessary changes of the projection image can be suppressed.

### Third Embodiment

The embodiment relates to a program that detects the operation performed on an object surface by the indicator. The case is described where the information processing device 100c that performs processing similar to that of the first or second embodiment is realized by a program on a computer. For simplification, an operation similar to that of the second embodiment is described.

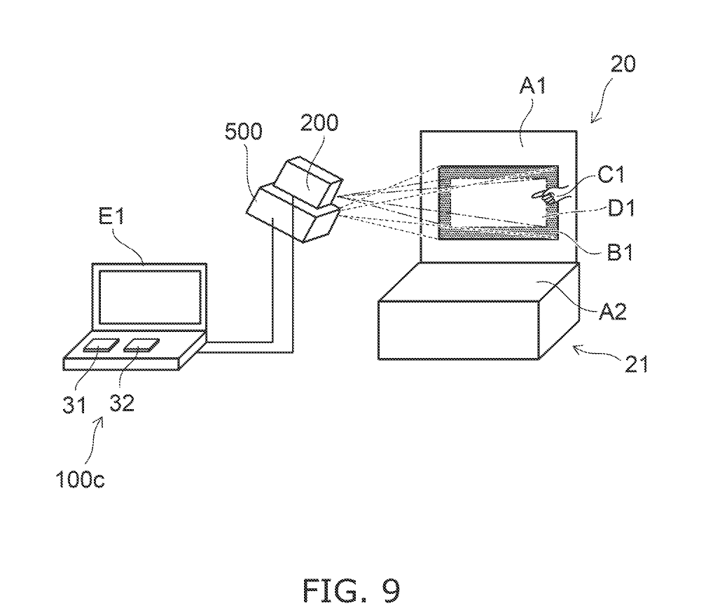

FIG. 9 is a schematic perspective view illustrating an example of the state of use of the information processing device according to the third embodiment.

In the example, a computer E1 is connected to the distance measuring unit 200 and the image projector 500. In the embodiment, the image projector 500 includes a projector. The computer E1 includes a processor 31 and a memory device 32. Although the memory device 32 includes a hard disk or the like, storage media such as CDs, DVDs, flash memory, etc., may be used. For example, a program for executing the information processing device 100c is stored in the memory device 32. For example, the program is acquired via a storage medium or a network and is appropriately installed in the computer E1. The processing of the information processing device 100c is executed by the program being executed by the processor 31. For example, the memory device 32 also is used as a buffer for retaining the distance information.

In the embodiment, the distance information is input to the computer E1 from the distance measuring unit 200 and is passed to the information processing device 100c. The image that is input is an image file, a video image file, etc., retained by the computer E1. The desktop screen of the computer E1 may be used as the input. The operation information that is detected by the operation detector 103 is output to the operating system (OS) on the computer E1; and an event such as clicking, tapping, flicking, magnification/reduction, or the like is initiated. The image after the conversion is transmitted to the image projector 500 and projected.

The embodiment is advantageous in that the introduction cost can be low because dedicated hardware is unnecessary because the information processing device can be realized by combining a distance measuring unit, a projector, and a computer.

In the embodiment, the storage medium that stores the program may be a computer-readable non-transitory storage medium. The storage medium may include, for example, CD-ROM (-R/-RW), a magneto-optical disk, a HD (hard disk), DVD-ROM (-R/-RW/-RAM), a FD (flexible disk), flash memory, a memory card, a memory stick, other various ROM, RAM, etc.

According to the embodiments, an information processing device that detects an operation performed by an indicator and has improved stability of the detection can be provided.

Hereinabove, embodiments of the invention are described with reference to specific examples. However, the embodiments of the invention are not limited to these specific examples. For example, one skilled in the art may similarly practice the invention by appropriately selecting specific configurations of components such as the distance information acquisition unit, the operation detector, the updating unit, the reference distance, the distance information, the indicator, the image converter, the distance measuring unit, the image projector, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all information processing devices, image projection devices and image processing methods practicable by an appropriate design modification by one skilled in the art based on the information processing devices, the image projection devices and the image processing methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An information processing device, comprising:
a distance information acquisition unit that acquires distance information relating to a distance to an object, the object including at least a portion of a projection surface where an image is projected;
an operation detector that detects an operation performed by an indicator, the detecting being based on a reference distance and the distance information; and
an updating unit that updates the reference distance based on a temporal change of the detected operation and a temporal change of the acquired distance information.

2. The information processing device according to claim 1, wherein the operation detector detects the operation based on a difference between the distance information and the reference distance.

3. The information processing device according to claim 1, wherein the updating unit does not update the reference distance when the operation is detected as being performed.

4. The information processing device according to claim 1, wherein the updating unit modifies the reference distance based on the distance information of a time of detecting that the operation is not being performed.

5. The information processing device according to claim 1, wherein the updating unit updates the reference distance when an interval of detecting that the operation is not being performed is longer than a predetermined interval.

6. The information processing device according to claim 1, wherein the updating unit updates the reference distance when the temporal change of the distance information is less than a reference value.

7. The information processing device according to claim 6, wherein the updating unit updates the reference distance when an interval of the temporal change of the distance information being less than the reference value is longer than a predetermined interval.

8. The information processing device according to claim 1, wherein the updating unit modifies the reference distance based on the distance information of a time of the temporal change of the distance information being less than a reference value, the time being a time of detecting that the operation is not being performed.

9. The information processing device according to claim 1, wherein
the distance information acquisition unit includes a buffer retaining a plurality of the distance information of mutually-different times, and
the updating unit updates the reference distance based on the plurality of distance information retained in the buffer.

10. The information processing device according to claim 1, further comprising an image converter that converts the image based on the updated reference distance.

11. The information processing device according to claim 10, wherein
the reference distance includes a first reference distance and a second reference distance,
the operation detector detects the operation based on the first reference distance,
the image converter converts the image based on the second reference distance, and
the updating unit updates the first reference distance in a first interval and updates the second reference distance in a second interval different from the first interval.

12. The information processing device according to claim 1, further comprising a distance measuring unit that measures a distance to the at least a portion of the projection surface,
the distance information being based on the distance between the distance measuring unit and the at least a portion of the projection surface.

13. The information processing device according to claim 1, further comprising an acceleration sensor provided in the image projector,
wherein the updating unit modifies a time of updating the reference distance based on information relating to at least one of a position of an image projector projecting the image or an orientation of the image projector, the at least one being detected by the acceleration sensor.

14. An image projection device, comprising:
the information processing device according to claim 1; and
an image projector projecting the image toward the object.

15. An image processing method, comprising:
acquiring distance information relating to a distance to an object, the object including at least a portion of a projection surface where an image is projected;
detecting an operation performed by an indicator, the detecting being based on a reference distance and the distance information; and
updating the reference distance based on a temporal change of the detected operation and a temporal change of the acquired distance information.

16. The method according to claim 15, wherein the operation is detected based on a difference between the distance information and the reference distance.

17. The method according to claim 15, wherein the reference distance is not updated when the operation is detected as being performed.

18. The method according to claim 15, wherein the reference distance is modified based on the distance information of a time of detecting that the operation is not being performed.
